(19) United States
(12) Patent Application Publication
(10) Pub. No.: US 2005/0210476 A1
(43) Pub. Date: Sep. 22, 2005

(54) Architecture and method for sharing application programs between multiple operating systems with feature of electricity saving

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/055,060

(22) Filed: Feb. 11, 2005

(30) Foreign Application Priority Data
Feb. 10, 2004 (TW) 093103100

(51) Int. Cl. G06F 9/46

(52) U.S. Cl. 719/310

(57) ABSTRACT

An architecture and method for sharing application programs between multiple operating systems with feature of electricity saving is disclosed. The architecture of computer system includes a first operating system that is installed in a first storage device, a second operating system that is compressed to be stored in a second storage device, and a virtual disk that is a disk storage device formed by simulation of part of area in a memory device. A basic input output system (BIOS) is used to boot the computer, then the second operating system is decompressed and is loaded into the virtual disc for being executed. Through an interface unit, the second operating system shares at least a data display program and a multimedia playback program with the first operating system. Thus the second storage device becomes in sleep mode. By reducing disc access, the electricity saving is achieved and the execution speed is increased effectively.

### BACKGROUND OF THE INVENTION

The present invention relates to an architecture and a method for sharing application programs between multiple operating systems with feature of electricity saving. By a basic input/output system, a compressed second operating system is decompressed and loaded into a virtual disk. Then through an interface unit, the second operating system shares at least a data display program and a multimedia playback program with the first operating system. Thus the disc access operations are reduced and the electricity saving is achieved.

Storage devices are like warehouses for computer systems. All of the information is stored inside the storage device while users want to run a program, the related data is loaded into memory. But sometimes the program is large or too many programs are running at one time, it is easy to over the capacity of the memory. In order to solve such problems, a technique called swapping is used. A space on the hard disk is used as if it were actual memory for holding needed data over the main memory. That is using part of the hard drive as memory when RAM is full. When RAM (random access memory) is full, the computer swaps data to the hard disk and back as needed. The currently used portion is then held in the quick RAM chips, and the currently unused portion is held in the Virtual Memory space on the hard disk. If the RAM is small, computer system is busy in exchanging information between memory and hard disk when swapping is required. Thus the execution speed is decreased.

By the development of the information technology, the capacity of memory is increased dramatically. Computer systems have more memory space and higher execution speed. A concept of RAM Disk (random access memory disk) is invented. A RAM disk is a simulated disk drive whose data is actually stored in RAM memory. Access to a RAM disk is far faster than access to hard disk drives. RAM disks are particularly useful with greater efficiency, therefore, for applications that require frequent disk accesses, especially under the condition that a larger space is needed for storage of programs while without partition.

Linux is introduced by Linus Torvalds in 1991 and is still under development. There are quite a lot of issues need to be overcome such as libraries, drivers for peripherals, Man-Machine Interface and application programs for Linux related products. There is a risk that compatibility, future development and technical support is not guaranteed. In comparison, Windows operating systems are developed and supported by Microsoft—the world's largest software maker. Thus they can provide enough technical support in various libraries, drivers for peripherals, Man-Machine Interface, application programs, chips and platforms. Moreover, the products provide enterprise-class manageability, availability, reliability, compatibility and performance. Integrated programs meet administrative as well as organizational needs and reduce cost for support. However, powerful system resources of Windows also increase its system loading. Thus its system stability and performance are not as good as Linux.

Thus there is a need to take advantages of the Linux and Windows operating systems, in combination with the higher execution speed of the RAM disk for reducing disk access so as to achieve the purpose of saving power.

### SUMMARY OF THE INVENTION

It is therefore a primary object of the present invention to provide an architecture and method for sharing application programs between multiple operating systems with feature of electricity saving. By a basic input output system, a second operating system with lower system loading is decompressed, loaded and installed into a virtual disc so that a second storage device is in sleep mode. Then through an interface unit, the second operating system shares at least a data display program and a multimedia playback program with a first operating system with higher system loading. Thus the purpose of electricity saving is achieved by reducing disc access.

It is another object of the present invention to provide an architecture and method for sharing application programs between multiple operating systems with better execution efficiency. A second operating system with lower system loading is decompressed, loaded and installed into a virtual disc by a basic input output system so as to make a second storage device in sleep mode. The virtual disk is a disk storage device simulated from part of area of a memory device and the work of frequent disk access is transferred into the virtual disk. Thus the execution efficiency is increased by reducing disk access.

It is a further object of the present invention to provide an architecture and method for sharing application programs between multiple operating systems with feature of satisfying users needs quickly. A second operating system in a virtual disk is initiated by a basic input output system. Then through an interface unit, the second operating system shares at least a data display program and a multimedia playback program with the first operating system. Thus the waiting time for initiating the first operating system with higher system (resource) loading is reduced so that users needs of playing multimedia and data programs are satisfied quickly.

It is a further object of the present invention to provide an architecture and method for sharing application programs between multiple operating systems with feature of portable systems. A second operating system is decompressed and stored in a second storage device with smaller storage space. By the portable feature of the second storage device, the second operating system is executed regardless of locations.

It is a further object of the present invention to provide an architecture and method for sharing application programs between multiple operating systems with feature of saving storage space. A second operating system shares a multimedia playback program with a first operating system so as to avoid the repeated installation of the application programs and save the storage space effectively.

In order to achieve above objects, an architecture and a method for sharing application programs between multiple operating systems with feature of electricity saving in accordance with the present invention is provided. The architecture includes a first operating system runs a plurality of programs; a second operating system, compressed and stored in a smaller second storage device, runs at least one program; and a virtual disk that is a disk storage device simulated from part of area of a memory device. A user end decompresses and loads the second operating system into the virtual disk by an input output system for initiating the second operating system and making the second storage device in sleep mode. Thus the power is saved by reducing disk access operations. The second operating system shares at least a data display program and a multimedia playback program with the first operating system through an interface unit. The second operating system transfers the frequent disk access into the virtual disk for increasing execution speed and reducing waiting time of initiating the first operating system with higher system resource consumption and larger storage space. The system also has features of system portability, resources sharing and saving of storage space. It can also avoid the repeated installation of application programs.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic diagram showing the initiation of a second operating system of an embodiment in accordance with the present invention;

FIG. 2 is a schematic diagram showing the initiation of a second operating system of another embodiment in accordance with the present invention;

FIG. 3 is a block diagram of an embodiment in accordance with the present invention;

FIG. 4 is a block diagram of another embodiment in accordance with the present invention;

FIG. 5 is a flow chart of an embodiment in accordance with the present invention.

### DETAILED DESCRIPTION OF THE PREFFERED EMBODIMENT

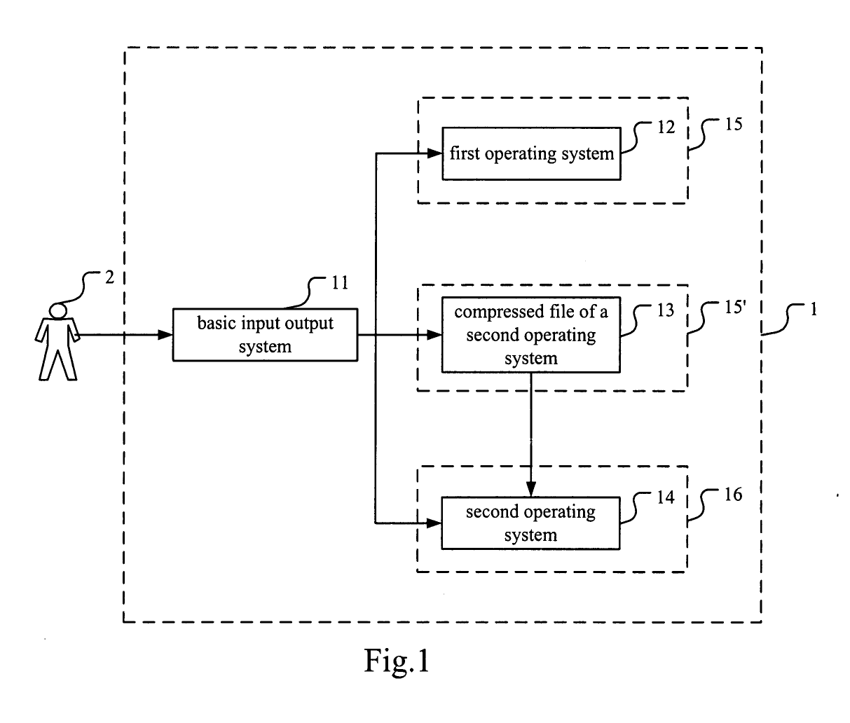

Refer to FIG. 1, an architecture in accordance with the present invention consists of: a computer system 1 with a basic input output system 11 for managing and controlling the booting of the computer host; a first operating system 12 installed at a first storage device 15 for running a plurality of programs; and a compressed file of a second operating system 13 stored in a second storage device 15′. A user end 2 boots the computer system by the basic input output system 11, decompresses the compressed file of a second operating system 13 into a second operating system 14 and loads as well as installs the second operating system 14 into a virtual disk 16. Then the second operating system 14 is executed so as to reduce the waiting time for initiating the first operating system 12 with higher system loading.

The second operating system 14 is executed in the virtual disk 16 so as to make the second storage device 15′ in sleep mode. And the frequent disk access is transferred into the virtual disk 16. Thus electricity saving is achieved and the execution efficiency is improved by reducing disk access.

The first operating system 12 is a Windows operating system, which is with higher loading of system resources, such as Windows XP, Windows NT, Window 98, Windows 2000 and Windows Me while the second operating system 14 is an operating system with lower loading of system resources such as Linux operating system.

The first storage device 15 needs a larger storage space in order to install the first operating system 12 with higher system loading. The first storage device 15 can be a hard disk or a read-only memory unit while the hard disk is a main device for storage. And the second storage device 15′ only has the second operating system 14 with lower system loading being installed therein and it can be a ROM (Read Only Memory), a hard disk with a USB (Universal Serial Bus) interface, or a hard disk. The hard disk with a USB interface is a main storage device and it is also a convenient as well as portable hard disk thus it is compatible with any computer with a USB slot for using the second operating system 14. The virtual disk 16 is a memory device having a part of the area being simulated into a disk storage device and the second operating system 14 is loaded and executed therein. Thus the disk access operations are converted into access of the memory unit in order to increase execution speed and reduce disk access operations effectively.

The basic input output system 11 is embedded with a decompression program so as to decompress the compressed file of the second operating system 13 for being loaded and installed in the virtual disk 16. The basic input output system 11 is reset by customization so as to be initiated and installed in the second operating system 14 in the virtual disk 16. Thus the waiting time for initiating the first operating system 12 with higher system loading is reduced.

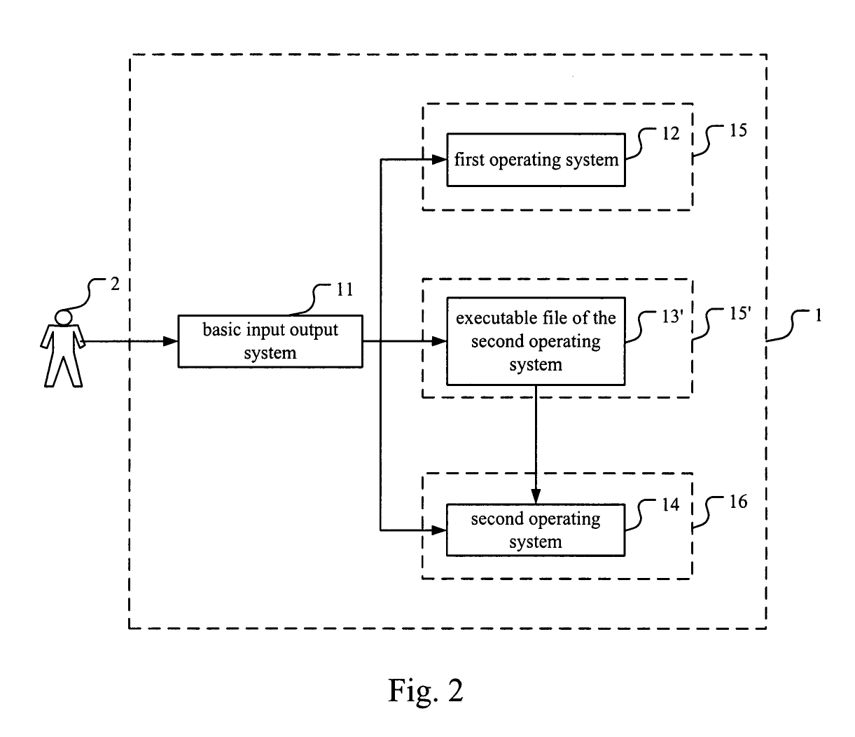

Refer to FIG. 2, another embodiment of the present invention is disclosed. The configuration of this embodiment is similar with the embodiment shown in FIG. 1 except that the second storage device 15′ is stored with an executable file of the second operating system 13′. When a user end 2 boots the computer system by the basic input output system 11, the executable file of the second operating system 13′ is run directly so that the second operating system 14 is loaded and installed into the virtual disk 16 for being executed.

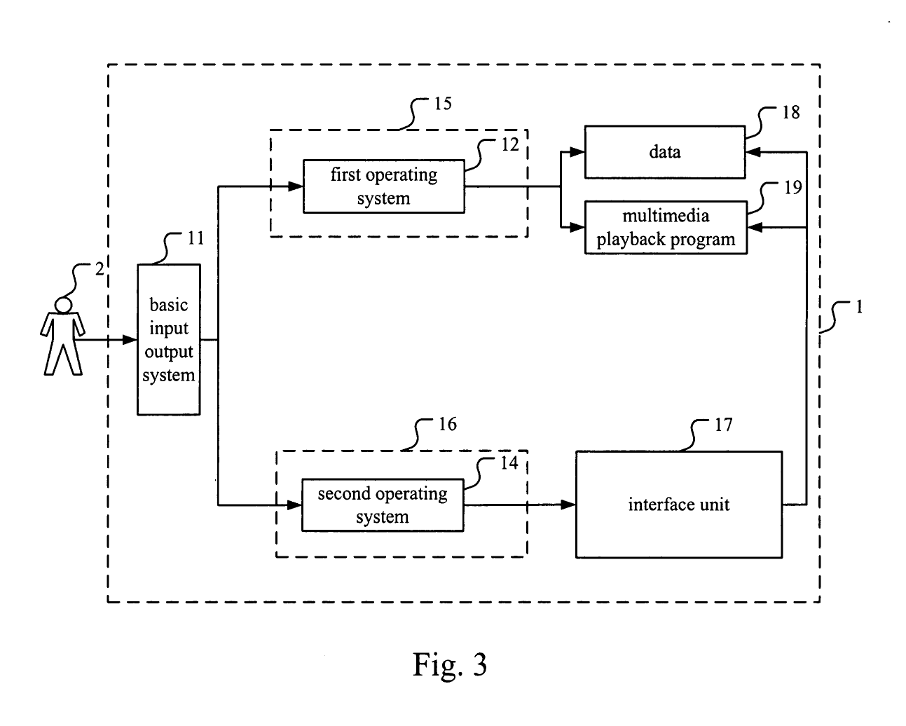

Refer to FIG. 3, the system includes a computer system 1 with a basic input output system 11 for managing and controlling the booting of the computer host; a first operating system 12 installed at a first storage device 15 for running a plurality of programs; at least a piece of data 18 stored inside a file system of the first operating system 12; a multimedia playback program 19 installed inside the first operating system 12 for running application programs to display films in DVD or VCD format; and a second operating system 14 installed in a virtual disk 16 for executing at least one program.

After a user end 2 booting the computer by the basic input output system 11, the second operating system 14 in the virtual disk 16 is executed. By an interface unit 17 converting related parameters of the data 18 and the multimedia playback program 19, the second operating system 14 is capable of sharing at least the data 18 and the multimedia playback program 19 with the first operating system 12 so as to reduce the waiting time for initiating the first operating system 12 with higher system resource consumption and larger storage space, avoid repeated installation of application programs and save storage space effectively.

When the multimedia playback program 19 needs larger memory space, the first storage device 15 can be simulated into a memory unit for storing application programs requiring more memory units.

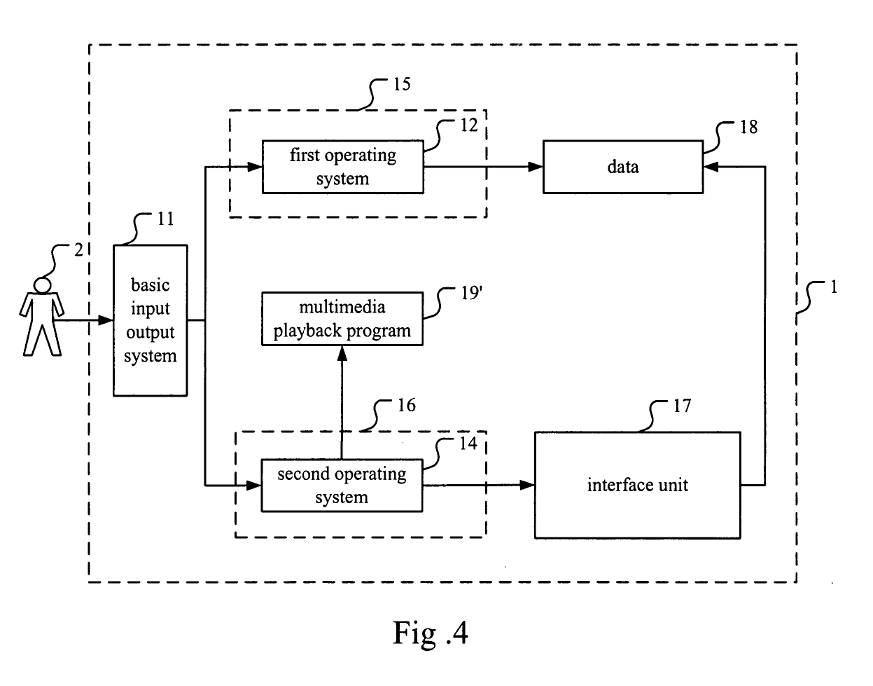

With reference of FIG. 4, a multimedia playback program 19′ is installed in a second operating system 14 that is able to run at least one program. After user end 2 turning on the computer by a basic input output system 11, the second operating system 14 in a virtual disk 16 is initiated and the multimedia playback program 19′ is executed. By an interface unit 17 converting related parameters of the data 18, the multimedia playback program 19′ shares the data 18 with a first operating system 12.

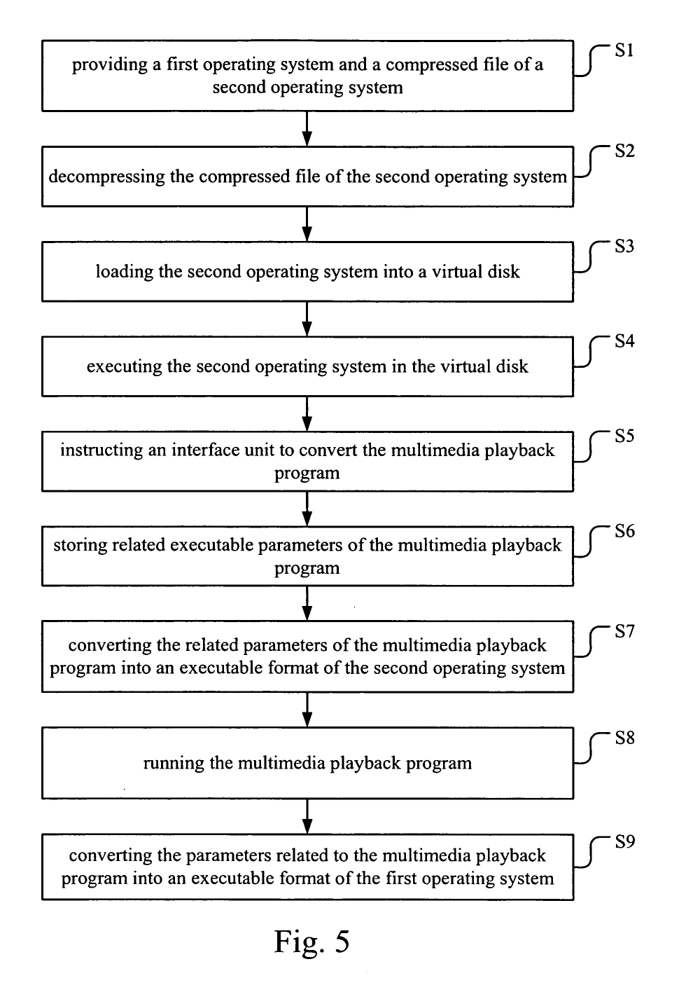

Refer to FIG. 5, the method for the user end 2 to run a multimedia playback program 19 in the first operating system 12 is composed by following steps:
step S1: providing a first operating system as well as a multimedia playback program installed in a first storage device with larger storage space and a compressed file of a second operating system installed in a second storage device with smaller storage space by a user end;
step S2: decompressing the compressed file of the second operating system by a basic input output system;
step S3: loading the second operating system into a virtual disk;
step S4: executing the second operating system in the virtual disk;
step S5: instructing an interface unit to convert the multimedia playback program inside the first operating system;
step S6: storing related executable parameters of the multimedia playback program in the first operating system;
step S7: converting the related parameters of the multimedia playback program into an executable format of the second operating system;
step S8: running the multimedia playback program and reporting the result to the user end; and
step S9: converting the parameters related to the multimedia playback program into an executable format of the first operating system after running the multimedia playback program;

In summary, the present invention relates to an architecture and method for sharing application programs between multiple operating systems with feature of electricity saving. By the basic input output system (BIOS), the computer is booted up and the second operating system in the virtual disk is executed. Thus the disk access operations are converted into virtual disk access so as to make the second storage device become in sleep mode. Therefore, the purposes of electricity-saving and higher execution speed are achieved. Furthermore, the second operating system shares at least a data display and a multimedia playback programs with the first operating system. Thus the waiting time for initiating the first operating system with higher system resource consumption and larger storage space is reduced. The computer system has features of portability, sharing resources, and savings on storage space. The repeated installation of application programs can also be avoided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. An architecture for sharing application programs between multiple operating systems with feature of electricity saving comprising
a first operating system;
a second operating system installed in a storage device;
a virtual disk that is a disk storage device simulated from part of area of a memory device; and
a basic input output system for loading the second operating system into the virtual disk.

2. The architecture as claimed in claim 1, wherein the second operating system is a compressed file.

3. The architecture as claimed in claim 2, wherein the basic input output system decompresses the compressed file.

4. The architecture as claimed in claim 1, wherein the second operating system is an executable file.

5. The architecture as claimed in claim 4, wherein the executable file is executed by the basic input output system.

6. The architecture as claimed in claim 1, wherein the storage device becomes in sleep mode after the basic input output system loading the second operating system into the virtual disk.

7. A method for sharing application programs between multiple operating systems with feature of electricity saving comprising the steps of:
providing a first operating system;
providing a second operating system installed in a storage device;
loading the second operating system into a virtual disk by a basic input output system; and
executing the second operating system inside the virtual disk.

8. The method as claimed in claim 7, further comprising the step of compressing the second operating system into a compressed file before providing the second operating system.

9. The method as claimed in claim 8, wherein the basic input output system is used to execute the step of compressing for decompressing the compressed file.

10. The method as claimed in claim 7, further comprising the step of compressing the second operating system into an executable file before providing the second operating system.

11. The method as claimed in claim 10, wherein the executable file is run by the basic input output system.

12. The method as claimed in claim 7, further comprising the step of making the storage device into a sleep mode after loading the second operating system into the virtual disk by the basic input output system.

13. An architecture for sharing application programs between multiple operating systems with feature of electricity saving comprising
a first operating system;
a multimedia playback program that is an application program installed in the first operating system for displaying DVD or VCD films;
a second operating system installed in a storage device;
a virtual disk that is a disk storage device simulated from part of area of a memory device; and
a basic input output system for loading the second operating system into the virtual disk;
wherein the second operating system executes conversion of parameters of the multimedia playback program through an interface unit for sharing the multimedia playback program with the first operating system.

14. The architecture as claimed in claim 13, wherein the second operating system is a compressed file.

15. The architecture as claimed in claim 14, wherein the basic input output system decompresses the compressed file.

16. The architecture as claimed in claim 13, wherein the second operating system is an executable file.

17. The architecture as claimed in claim 16, wherein the executable file is executed by the basic input output system.

18. The architecture as claimed in claim 13, wherein the storage device becomes in sleep mode after the basic input output system loading the second operating system into the virtual disk.

19. A method for sharing application programs between multiple operating systems with feature of electricity saving comprising the steps of:
providing a first operating system;
providing a multimedia playback program installed in the first operating system;
providing a second operating system installed in a storage device;
loading the second operating system into a virtual disk by a basic input output system;
executing the second operating system inside the virtual disk; and
converting parameters of the multimedia playback program by an interface unit so as to make the second operating system share the multimedia playback program with the first operating system.

20. The method as claimed in claim 19, further comprising the step of compressing the second operating system into a compressed file before providing the second operating system.

21. The method as claimed in claim 20, wherein the basic input output system is used to execute the step of compressing for decompressing the compressed file.

22. The method as claimed in claim 19, further comprising the step of compressing the second operating system into an executable file before providing the second operating system.

23. The method as claimed in claim 22, wherein the executable file is run by the basic input output system.

24. The method as claimed in claim 19, further comprising the step of making the storage device into a sleep mode after loading the second operating system into the virtual disk by the basic input output system.

25. An architecture for sharing application programs between multiple operating systems with feature of electricity saving comprising
a first operating system having a file system recording at least one piece of data;
a second operating system installed in a storage device;
a multimedia playback program that is an application program installed in the second operating system for displaying DVD or VCD films;
a virtual disk that is a disk storage device simulated from part of area of a memory device; and
a basic input output system for loading the second operating system into the virtual disk;
wherein the multimedia playback program converts the data through an interface unit for sharing the data with the first operating system.

26. The architecture as claimed in claim 25, wherein the second operating system is a compressed file.

27. The architecture as claimed in claim 26, wherein the basic input output system decompresses the compressed file.

28. The architecture as claimed in claim 27, wherein the second operating system is an executable file.

29. The architecture as claimed in claim 28, wherein the executable file is executed by the basic input output system.

30. A method for sharing application programs between multiple operating systems with feature of electricity saving comprising the steps of:
providing a first operating system;
providing at least one piece of data of a file system of the first operating system;
providing a second operating system installed in a storage device;
loading the second operating system into a virtual disk by a basic input output system;
executing the second operating system inside the virtual disk;
executing a multimedia playback program in the second operating system; and
converting the data by an interface unit so as to make the multimedia playback program of the second operating system share the data with the first operating system.

31. The method as claimed in claim 30, further comprising the step of making the storage device into a sleep mode after loading the second operating system into the virtual disk by the basic input output system.
